(19) United States
(12) Patent Application Publication
(10) Pub. No.: US 2004/0160181 A1
(43) Pub. Date: Aug. 19, 2004

(54) Incandescent lamp for vehicle headlights

(75) Inventors: Christian Seichter, Herbrechtingen (DE); Klaus Wittmann, Sontheim (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, MUNCHEN (DE)

(21) Appl. No.: 10/771,378

(22) Filed: Feb. 5, 2004

(30) Foreign Application Priority Data
Feb. 13, 2003 (DE) 103 06 178.9

(51) Int. Cl. H01K 1/50

(52) U.S. Cl. 313/569

(57) ABSTRACT

The invention relates to an incandescent lamp for vehicle headlights, the incandescent lamp having at least one incandescent filament and a shading apparatus for the at least one incandescent filament, which are both arranged in a lamp vessel, and having power supply lines for the at least one incandescent filament, a first power supply line being connected to the shading apparatus. The abovementioned power supply line has a bent-back end, which is connected to an outgoing filament line of the at least one incandescent filament.

### I. TECHNICAL FIELD

The invention relates to an incandescent lamp for vehicle headlights having at least one incandescent filament and a shading apparatus for the at least one incandescent filament, which are arranged in a lamp vessel, and having power supply lines for the at least one incandescent filament, a first power supply line being connected to the shading apparatus. In particular, the invention relates to a two-filament halogen incandescent lamp for motor vehicle headlights.

### II. BACKGROUND ART

An incandescent lamp of this type is disclosed, for example, in the patent application DE 195 44 012. This patent application describes a two-filament halogen incandescent lamp for a motor vehicle headlight having two incandescent filaments and a shading apparatus, which are arranged in the lamp vessel. One of the incandescent filaments, which is referred to as the secondary filament, generally serves the purpose of producing the low beam, whereas the other incandescent filament, which is referred to as the main filament, generally serves the purpose of producing the high beam. The secondary filament is arranged close to the shading apparatus, so that its light is partially shaded by the shading apparatus. One outgoing filament line of the secondary filament is threaded through an aperture in the shading apparatus and welded to a power supply wire. The aperture may result in the parasitic light component being increased in an undesirable manner.

### III. DISCLOSURE OF THE INVENTION

It is the object of the invention to provide a generic incandescent lamp with an improved means of suspending the incandescent filament, which is arranged close to the shading apparatus.

This object is achieved by an incandescent lamp for vehicle headlights having at least one incandescent filament and a shading apparatus for the at least one incandescent filament, which are arranged in a lamp vessel, and having power supply lines for the at least one incandescent filament, a first power supply line being connected to the shading apparatus, wherein the first power supply line has a bent-back end, which is connected to an outgoing filament line of the at least one incandescent filament. Particularly advantageous refinements of the invention are described in the dependent patent claims.

The incandescent lamp according to the invention has at least one incandescent filament and a shading apparatus for the at least one incandescent filament, which are arranged in a lamp vessel, and power supply lines for the at least one incandescent filament, a first power supply line being connected to the shading apparatus, and the first power supply line having a bent-back end, which is connected to an outgoing filament line of the at least one incandescent filament. These measures improve the suspension of the incandescent filament, since the outgoing filament lines of the incandescent filament are not connected to the shading apparatus but rather connected directly to the power supply wires, and an aperture is not required in the shading apparatus in order to connect the outgoing filament lines of the incandescent filament to the power supply wires. In particular, there is also no need to provide a welded joint on the shading apparatus for an outgoing filament line. This makes it possible to reduce the dimensions of the shading apparatus.

In order to ensure that the suspension of the filament is as stable as possible, the bent-back end of the first power supply line is advantageously in the form of a hook. The shading apparatus preferably extends between the limbs of the end, in the form of a hook, of the first power supply line. This makes it possible to use the first power supply line both for fixing the shading apparatus and for suspending the filament. There is preferably a welded connection between one limb of the end, in the form of a hook, of the first power supply line and one outgoing filament line of the incandescent filament. The abovementioned limb is advantageously bent back in the direction of the incandescent filament in order to allow for a short outgoing filament line. In addition, the bent-back end or the abovementioned limb of the first power supply line is at a shorter distance from the surface of the shading apparatus which faces the at least one incandescent filament than the section of the at least one incandescent filament which is responsible for the light emission, in order to prevent the light/dark boundary from being impaired by the light which is scattered at the end in the form of a hook. A molybdenum or tantalum metal film advantageously covers the outgoing filament line of the at least one incandescent filament, which is connected to the abovementioned bent-back end of the power supply line, in order to ensure a good welded connection. The molybdenum or tantalum metal film can be welded more effectively to the molybdenum power supply wire than the tungsten outgoing filament line of the incandescent filament.

### VI. BRIEF DESCRIPTION OF THE DRAWINGS

The invention is explained in more detail below with reference to two preferred exemplary embodiments. In the drawing:

FIG. 1 shows the suspension of an incandescent filament in an incandescent lamp in accordance with the first preferred exemplary embodiment of the invention,

FIG. 2 shows the suspension of an incandescent filament in an incandescent lamp in accordance with the second preferred exemplary embodiment of the invention, and

FIG. 3 shows a side view of the incandescent lamp according to the invention.

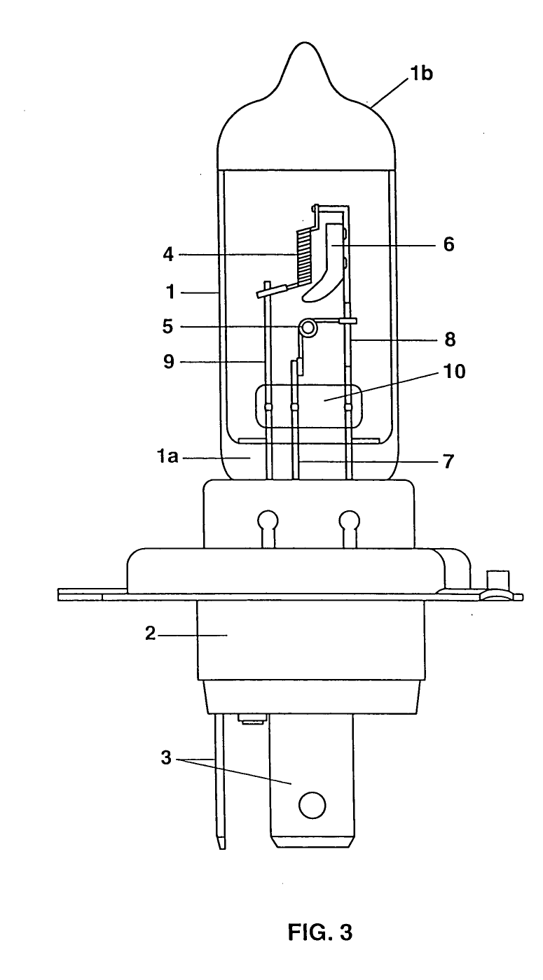

### V. BEST MODE FOR CARRYING OUT THE INVENTION

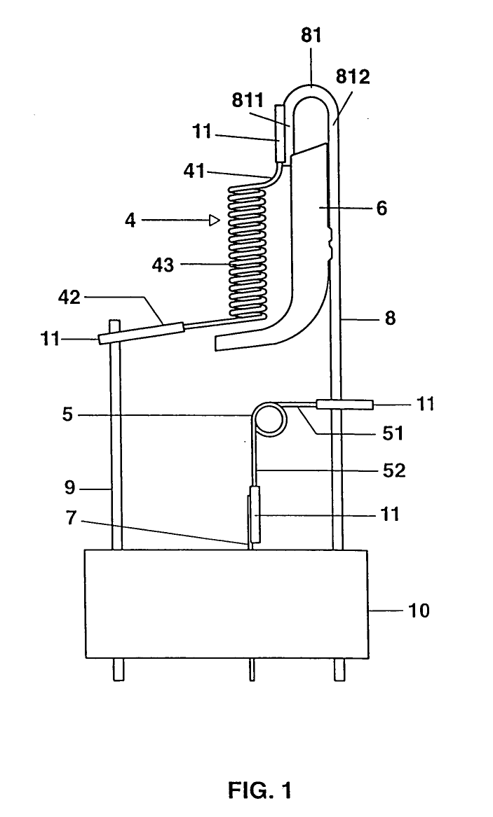

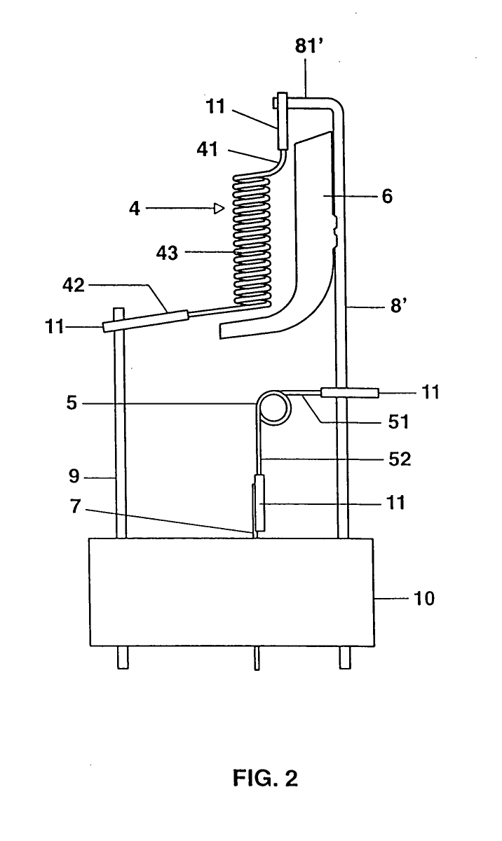

The preferred exemplary embodiments of the invention are two-filament halogen incandescent lamps which are provided for use in motor vehicle headlights. These lamps have two incandescent filaments 4, 5 and a shading device 6, which are enclosed in an essentially cylindrical, hard-glass or silica-glass lamp vessel 1. The first incandescent filament 4, which is also referred to as the secondary filament, serves the purpose of producing the low beam and is arranged close to the shading device 6, which partially shades the light emitted by the secondary filament 4. The second incandescent filament 5, which is also referred to as the main filament, serves the purpose of producing the high beam. The lamp vessel 1 has a sealed-off end 1a, which is fixed in the lamp base 2. The lamp base 2 has three contact lugs 3, which are each electrically conductively connected to the incandescent filaments 4, 5 via a power supply line 7, 8, 9. The power supply lines 7, 8, 9 are embedded in the sealed-off end 1a of the lamp vessel 1 in a gas-tight manner. The silica-glass bar 10 serves the purpose of fixing the power supply wires 7, 8, 9 during the assembly of the lamp mount 4, 5, 6, 7, 8, 9. Details of the suspension of the incandescent filament are illustrated in FIGS. 1 and 2.

FIG. 1 shows the suspension of the incandescent filament in accordance with the first exemplary embodiment of the invention. A molybdenum film 11, which is welded to the end 81, in the form of a hook, of the power supply wire 8, covers the first outgoing filament line 41 of the secondary filament 4. The end 81 in the form of a hook is roughly U-shaped. The shading device 6 extends between the two limbs 811, 812 of the end 81, in the form of a hook, of the power supply line 8. The distance between the U-limb 811 and the surface of the shading device 6 which faces the incandescent filament 4 is smaller than the distance between the coiled region 43 of the secondary filament 4 which is responsible for the light emission and the abovementioned surface of the shading device 6. The surface of the shading device 6 which is remote from the secondary filament 4 is welded to the power supply wire 8. A molybdenum film 11 surrounds the second outgoing filament line 42 of the secondary filament 4, and said second outgoing filament line is welded to the power supply line 9. A molybdenum film 11 is wrapped around the first outgoing filament line 51 of the main filament 5, and said first outgoing filament line is welded to the power supply line 8, whereas its second outgoing filament line 52, which also has a molybdenum film 11 wrapped around it, is welded to the power supply line 7.

FIG. 2 shows the suspension of the incandescent filament in accordance with the second exemplary embodiment of the invention. This suspension of the incandescent filament differs from that of the first exemplary embodiment only in the design of the power supply line 8 and 8′, respectively. The same reference numerals have therefore been used in FIGS. 1 and 2 for identical lamp parts. A molybdenum film 11, which is welded to the bent-back end 81′ of the power supply line 8′, covers the first outgoing filament line 41 of the secondary filament 4. A molybdenum film 11 is wrapped around the second outgoing filament line 42 of the secondary filament 4, and said second outgoing filament line is welded to the power supply wire 9. The distance between the end of the bent-back section 81′ and the surface of the shading device 6 which faces the secondary filament 4 is smaller than the distance between the coiled region 43 of the secondary filament 4 which is responsible for the light emission and the abovementioned surface of the shading device 6. This prevents the light scattered at the end of the bent-back section 81′ from disturbing the formation of a sharp light/dark boundary. The light/dark boundary for the low beam is defined by the contour of the secondary filament 4, in particular by the projection of the surface of the secondary filament 4 which faces the shading device 6. The surface of the shading device 6 which is remote from the secondary filament 4 is welded to the power supply wire 8′. A molybdenum film 11 is wrapped around the first outgoing filament line 51 of the main filament 5, and said first outgoing filament line is welded to the power supply line 8′, whereas its second outgoing filament line 52, which also has a molybdenum film 11 wrapped around it, is welded to the power supply line 7.

The invention is not limited to the exemplary embodiments explained in more detail above. The two incandescent filaments 4, 5 do not necessarily have to have single-coil, light-emitting sections 43 and uncoiled outgoing filament lines, but instead may also have twin-coil, light-emitting sections and single-coil outgoing filament lines. In addition, the molybdenum films 11 may be dispensed with, if desired. The molybdenum films 11 only act as a welding aid since they can be welded more effectively to the likewise molybdenum power supply wires 7, 8, 9 than the tungsten outgoing filament lines of the incandescent filaments 4, 5.

What is claimed is:

1. An incandescent lamp for vehicle headlights, the incandescent lamp having at least one incandescent filament and a shading apparatus for said at least one incandescent filament, which are arranged in a lamp vessel, and having power supply lines for said at least one incandescent filament, a first power supply line being connected to said shading apparatus, wherein said first power supply line has a bent-back end, which is connected to an outgoing filament line of said at least one incandescent filament.

2. The incandescent lamp as claimed in claim 1, wherein said bent-back end of the first power supply line is in the form of a hook.

3. The incandescent lamp as claimed in claim 2, wherein said shading apparatus extends between the limbs of said end, in the form of a hook, of the first power supply line.

4. The incandescent lamp as claimed in one of claims 1, wherein said bent-back end of the first power supply line is at a shorter distance from the surface of said shading apparatus which faces said at least one incandescent filament than the section of said at least one incandescent filament which is responsible for the light emission.

5. The incandescent lamp as claimed in claim 1, wherein a molybdenum or tantalum metal film covers said outgoing filament line, which is connected to said bent-back end.
